(19) United States
(12) Patent Application Publication
(10) Pub. No.: US 2024/0383800 A1
(43) Pub. Date: Nov. 21, 2024

(54) METHOD FOR REGENERATING A SALT MELT FOR A GLASS HARDENING AND/OR GLASS SOLIDIFICATION PROCESS

(71) Applicant: 2MH GLAS GMBH, Freiberg (DE)

(72) Inventors: Thomas VOLAND, Grossweitzchen (DE); Sabine HÖNIG, Dittmannsdorf (DE); Martin GROSS, Pockau-Lengefeld (DE); Michael HEIDAN, Dietzenbach (DE)

(21) Appl. No.: 18/580,643

(22) PCT Filed: Jul. 21, 2022
(86) PCT No.: PCT/EP2022/070518

§ 371 Date: Jul. 24, 2024

(30) Foreign Application Priority Data
Jul. 23, 2021 (LU) LU500469

(51) Int. Cl. C03C 21/00

(52) U.S. Cl. CPC C03C 21/002

(57) ABSTRACT

The invention relates to a method for regenerating a salt melt for a glass hardening and/or glass solidification process. The method is characterized in that at least a first regeneration material body of a first regeneration material and a second regeneration material body of a second regeneration material, which is different from the first regeneration material, is simultaneously or sequentially brought into contact with the salt melt. The invention also relates to an installation for hardening and/or solidifying glass, comprising a salt bath with a salt melt.

### CROSS-REFERENCE TO RELATED APPLICATIONS

The present application is a national phase entry under 35 USC § 371 of International Application PCT/EP2022/070518 filed Jul. 21, 2022, claiming priority to and benefit of Luxembourgian Patent Application No. 500469 filed Jul. 23, 2021, the entire disclosure of which is incorporated herein by reference.

### FIELD

The disclosure relates to a method of regenerating a salt melt for a glass hardening and/or glass solidification process.

The disclosure also relates to a plant for hardening and/or solidifying glass, including a salt bath containing a salt melt.

### BACKGROUND

It is known that ion exchange within a thin surface layer can achieve significant compressive stresses that considerably improve the strength properties of the glass when glass is subjected to a defined treatment in a salt melt. In the treatment in a salt melt, ions of a first type migrate into the glass, while the glass simultaneously releases ions of a second type into the salt melt. A drawback is that the effect of the salt melt decreases as a function of the frequency of its use, especially because the salt melt becomes depleted of ions of the first type, and ions of the second type accumulate in the salt melt. The effect of this is that the salt melt frequently has to be exchanged.

In particular, a known method is to conduct a prestressing process at elevated temperatures in a salt melt composed of potassium nitrate or a mixture comprising potassium nitrate, wherein smaller alkali metal ions (sodium, lithium) are exchanged for larger alkali metal ions. However, the exchanged alkali metal ions remain in the salt melt, which reduces the efficacy of the salt melt. Moreover, it is disadvantageous for the outcome of the prestressing process that there is a breakdown of the salt melt via the nitrite to the oxide/hydroxide.

The increasing deterioration in efficacy of the salt melt can at least be delayed by the use of a regeneration material.

For example, DE 17 71 232 B2 discloses a method of exchanging ions between a salt melt and glass for the purpose of altering the properties thereof, with uptake of the ions that have migrated into the salt melt by a regeneration material present in a separate phase in the salt melt and simultaneous release of ions required in the ion exchange to the salt melt. A salt melt is used that has an added auxiliary substance as regeneration material which is an acceptor for oxygen ions or has an acid function and is capable of complexation involving the ions that have migrated out of the glass or out of the regeneration material into the salt melt and promotes redox reactions in the salt melt.

### SUMMARY

It is an object of the present disclosure to specify a method that enables usability of the salt melt for hardening and/or solidifying a particularly large number of glass articles and/or particularly large glass articles with a high quality of the salt melt even in the case of glass articles made of complex glass material.

The object is achieved by a method which is characterized in that at least one first regeneration material body composed of a first regeneration material and a second regeneration material body composed of a second regeneration material other than the first regeneration material are contacted simultaneously or sequentially with the salt melt.

It is a further object of the present disclosure to specify a plant of the type specified at the outset, which permits the hardening and/or solidifying of a particularly large number of glass articles without having to exchange the salt melt.

This further object is achieved by a plant which is characterized in that the plant has at least one first regeneration material body composed of a first regeneration material and at least one second regeneration material body composed of a second regeneration material other than the first regeneration material that are continually in contact with the salt melt or are simultaneously or sequentially contactable with the salt melt.

It has been recognized in an inventive manner that the depletion of the salt melt of one type of larger alkali metal ions, for example potassium, and the enrichment with one type of smaller alkali metal ions, for example sodium, is not the sole cause of the deterioration in the quality of the salt melt with regard to the glass hardening and/or glass solidification process of glass articles. Instead, it has been found that, especially in the hardening and/or solidifying of glass articles made from complex glass materials, multiple influencing factors adversely affect the quality of the salt melt. In particular, it has been found in an advantageous manner that several different chemical substances have to be removed from the salt bath and/or several different chemical substances have to be introduced into the salt bath in order to assure proper functioning of ion exchange in a hardening/solidifying operation over a prolonged period.

It has been recognized in an inventive manner, for example, that in the course of hardening and/or solidification of glass articles made from a glass material including sodium and lithium, the quality of the salt melt is worsened both by the accumulation of sodium and additionally, actually to a greater degree, by the accumulation of lithium. An additional factor is often a continual increase in basicity of the salt melt with the number of glass hardening and/or glass solidification processes conducted, which likewise has an adverse effect on the quality of the salt melt with regard to the glass hardening and/or glass solidification process.

What is envisaged in an inventive manner is the use not merely of a single regeneration material but rather of at least two regeneration material bodies composed of different regeneration material, where, for example, a first regeneration material may be designed to take up sodium and hence remove it from the salt bath, and a second regeneration material may be designed to take up lithium and hence remove it from the salt bath. In addition, it may advantageously be the case, for example, that one of the regeneration materials is designed to eliminate or at least reduce basicity of the salt melt, which can be implemented, for example, in that the regeneration material in question includes silicon dioxide in order to bind OH groups from the salt bath and hence to remove them from the salt bath.

The disclosure has the very particular advantage that the use of two (or more) different regeneration materials can specifically and effectively counteract the usually several aging processes that occur. In a particular concept of the disclosure, it is especially possible to contact the different regeneration material bodies successively with the salt melt. This has the particular advantage that the different regeneration materials at least cannot directly adversely affect one another. Depending on the application, however, it is also possible to use the different regeneration materials simultaneously or at least with a time overlap in the same salt melt, unless there is a risk that the different regeneration materials adversely affect one another, or if the degree of direct or indirect mutual influence is small.

A very particularly advantageous method of hardening and/or solidifying glass articles is one in which the glass articles are contacted with a salt melt and in which the salt melt is regenerated continuously or at time intervals, in particular regular time intervals, by simultaneous or sequential contacting with at least one first regeneration material body composed of a first regeneration material and one second regeneration material body composed of a second regeneration material other than the first regeneration material. In particular, it is also possible to use a third regeneration material body (and optionally still further regeneration material bodies) composed of a third regeneration material other than the first and second regeneration materials for regeneration of the salt melt by simultaneous or sequential contacting.

In particular, it may advantageously be the case that two or more first regeneration material bodies, for example in the form of spheres, pellets, frits, fibers or platelets, composed of the first regeneration material and/or two or more second regeneration material bodies, for example in the form of spheres, pellets, frits, fibers or platelets, composed of the second regeneration material are contacted simultaneously or sequentially with the salt melt. In this way, a high surface area compared to volume is advantageously achieved, and hence a high contact area with the salt melt, such that high efficacy can be achieved for a given regeneration material use.

Very particularly advantageous first and/or second regeneration material bodies are those in the form of irregularly corrugated sheets and/or sheets with an irregular surface, because these cannot adhere face-to-face with one another, which would disadvantageously reduce the total effective surface area of the regeneration material bodies. Quite generally, it is therefore advantageously envisaged that the first regeneration material bodies have a similar basic shape, although the individual regeneration material bodies differ to such an extent that face-to-face adhering (as in the case, for example, of flat sheets) is avoided. The same applies analogously in relation to the second regeneration material body.

The first regeneration material bodies may advantageously have a mutually identical or at least similar shape and/or size. Alternatively or additionally, the second regeneration material bodies may have a mutually identical or at least similar shape and/or size. The shape and/or size of the first regeneration material bodies may be the same as the shape and/or size of the second regeneration material bodies. However, it is advantageous when the at least one first regeneration material body differs from at least one second regeneration material body in terms of shape and/or size. This has the particular advantage that misidentification can be avoided and that the different regeneration material bodies, when they are used simultaneously, can be separated from one another by a screening operation if required.

The at least one first regeneration material body may advantageously take the form of a sphere or of a sheet or of a (preferably irregularly) corrugated sheet or of a frit or of a fiber. Alternatively or additionally, the at least one second regeneration material body may also take the form of a sphere or of a sheet or of a (preferably irregularly) corrugated sheet or of a sheet with an irregular surface or of a frit.

Preference is given to using two or more first regeneration material bodies and/or two or more second regeneration material bodies, where these are advantageously contacted with the salt melt, for example, in the form of a pelletized material. In particular, it may advantageously be the case that the pelletized material has a grain size in the range from 0.1 mm to 10 mm, especially in the range from 0.1 mm to 3 mm or 0.1 mm to 0.8 mm or in the range from 0.3 mm to 0.8 mm. Such a grain size offers the advantage firstly that the pelletized material can be held within a vessel having comparatively large openings, while it simultaneously offers a high contact surface area for the salt melt.

Alternatively, two or more first regeneration material bodies and/or two or more second regeneration material bodies may be used in the form of glass frits or sintered material. Such a form firstly offers the advantage that the regeneration material bodies can be held within a (preferably dedicated) vessel having comparatively large openings, while there is simultaneously a high contact surface area for the salt melt. The glass frits may have a thickness in the range from 0.1 mm to 10 mm, especially in the range from 0.1 mm to 3 mm or 0.1 mm to 0.8 mm or in the range from 0.3 mm to 0.8 mm.

Alternatively, and with the same advantages, it is also possible that the first regeneration material bodies and/or second regeneration material bodies take the form of (preferably irregularly corrugated) sheets or (preferably irregularly and/or irregularly corrugated) fragments of sheets and the sheets or fragments are contacted with the salt melt. The sheets or the fragments of sheets may advantageously have a thickness in the range from 0.1 mm to 10 mm, especially in the range from 0.1 mm to 3 mm or 0.1 mm to 0.8 mm or in the range from 0.3 mm to 0.8 mm. The production of the sheets or fragments of sheets may include, for example, rolling-out of regeneration material. The roll here is preferably not smooth in order to impart a structure to the sheets or fragments of sheets that makes it impossible for them to adhere face-to-face.

Alternatively, and with the same advantages, it is also possible that the first regeneration material bodies and/or second regeneration material bodies are contacted with the salt melt in the form of fibers, especially of glass fibers, or in the form of at least one nonwoven produced from fibers, especially from glass fibers, or in the form of fiber wool, especially glass wool. The fibers may advantageously have a thickness in the range from 0.1 mm to 3 mm, especially in the range from 0.1 mm to 0.8 mm or in the range from 0.3 mm to 0.8 mm.

In a very particularly advantageous execution, at least one of the regeneration materials is a glass or includes a glass. This has the particular advantage that the regeneration material bodies can be contacted easily with the salt melt as solid-state bodies, for example in the form of spheres or glass fibers or of nonwoven material or glass frits or sintered material. For example, introduction of the regeneration material bodies into the salt bath and removal again from the salt bath is possible in a simple and uncomplicated manner. Alternatively, these regeneration material bodies can easily be disposed in a channel through which a portion of the salt melt is directed continually or at time intervals.

When the regeneration material is a glass, there is advantageously also complete recyclability. In particular, the regeneration material bodies, after use thereof as raw material, can be used for other applications or as raw material for production of glass articles.

In a particularly advantageous manner, at least one of the regeneration materials may be a glass, in particular a porous glass, composed of a glass system having a tendency to separate or include a glass, in particular a porous glass, composed of a glass system having a tendency to separate. In particular, at least one of the regeneration materials may be a silicon dioxide-rich, in particular porous, glass or include a silicon dioxide-rich, in particular porous, glass.

In a particular execution, at least one of the regeneration materials is a VYCor glass or includes a VYCor glass. VYCOR glass is produced in a particular process at comparatively low temperatures. Quartz glass production typically requires temperatures of 2000 degrees Celsius, whereas the VYCOR process permits production at temperatures of 1000 degrees Celsius to 1300 degrees Celsius [C]. The VYCOR process may especially include the process steps of melting of the raw glass (composition in the ternary system for example: M₂O—B₂O₃—SiO₂), shaping of the raw glass, thermal treatment (in a time- and temperature-dependent manner), etching of the surface of the shaped bodies (hydrofluoric acid, sodium hydroxide solution, mechanical), a washing process (alcohol, water, dilute soda solution), an extraction process (acids, inorganic salt solutions, 90 to 100° C.), a washing process, a drying process and/or a sintering process (1000 to 1300° C.). In the sintering process, the porous glass is usually sintered with a 30 percent contraction in volume to give a clear and virtually pure silica glass. It is advantageously also possible to add aluminum oxide to the VYCOR glass melt, which is advantageous for control of the phase separation and leaching process.

Alternatively or additionally, it may advantageously be the case that at least one of the regeneration materials includes amorphous silica. Regeneration material bodies composed of such a regeneration material have the very particular advantage that they counteract basicity of the salt melt. A porous glass here has the very particular advantage of a high contact area with the salt melt and therefore gives high efficacy.

In a particularly advantageous execution, one of the regeneration materials is designed to take up calcium from the salt melt. It has been found that the chemical and physical processes in a glass hardening and/or a glass solidification process are often hindered by calcium. The calcium usually comes from the glass articles to be hardened and/or solidified. For that reason, it is advantageous to remove calcium from the salt melt or to reduce the calcium content. In particular, it may advantageously be the case that at least one of the regeneration materials includes calcium, for example in the form of calcium oxide, but is designed not to release calcium into the salt melt.

In a particularly advantageous execution, one of the regeneration materials is designed to take up lithium from the salt melt. It has been found that the chemical and physical processes in a glass hardening and/or glass solidification process can often be hindered by lithium. The lithium usually comes from the glass articles to be hardened and/or solidified. For that reason, it is advantageous to remove lithium from the salt melt or to reduce the lithium content. In particular, it may advantageously be the case that at least one of the regeneration materials includes lithium, but is designed not to release lithium into the salt melt.

In a very particularly advantageous execution, the first regeneration material is designed to take up calcium from the salt melt, while the second regeneration material is designed to take up lithium from the salt melt. It has been found that sequential contacting of the salt melt with the at least one first regeneration material body and the at least one second regeneration material body is particularly advantageous here in order that the regeneration materials do not directly affect one another. However, simultaneous use of the at least one first regeneration material body and the at least one second regeneration material body is not fundamentally ruled out.

In a very particularly advantageous execution, one of the regeneration materials is potassium-containing silicate glass, especially a potassium aluminosilicate glass. This regeneration material has the very particular advantage that three very significant aging phenomena of the salt melt can be avoided or at least very significantly delayed. In particular, a rise in the concentration of extrinsic alkali metal ions is avoided or at least very significantly delayed. Moreover, a rise in pH of the salt melt by salt breakdown is avoided or at least very significantly delayed. In addition, particulate impurities are avoided; this is accomplished in particular in that particulate impurities of the salt melt are bound as soon as they come into contact with this regeneration material within the salt melt. Moreover, this regeneration material does not have any adverse effects on a plant for hardening and/or solidifying glass articles. Such a regeneration material in particular does not cause any corrosive reactions with the glass articles to be hardened and/or solidified or with the salt melt. Especially since this regeneration material is a glass, there is advantageously complete recyclability. In particular, this regeneration material, after use in accordance with the disclosure, can be used particularly easily as raw material for other applications or as raw material for production of glass articles. For example, this regeneration material, after use in accordance with the disclosure, can be cleaned to free it of still-adhering salt and be used as raw material for the production of silicatic bulk glasses.

In an advantageous execution, at least one of the regeneration materials has been melted from a raw material mixture including, apart from potassium oxide, additionally at least one further oxide, especially from the group of: aluminum oxide, boron oxide, sulfur oxide, calcium oxide. In particular, it may advantageously be the case that at least one of the regeneration materials has been melted from a raw material mixture including, apart from potassium oxide, additionally several oxides, especially from the group of: aluminum oxide, boron oxide, sulfur oxide, calcium oxide, in identical or different proportions.

A very particularly advantageous and effective regeneration material of the above-specified type is one that has been melted from a raw material mixture having a proportion of silicon oxide in the range from 40 percent by mass to 75 percent by mass, especially in the range from 50 percent by mass to 65 percent by mass, or of 57.5 percent by mass.

Alternatively or additionally, it may advantageously be the case that at least one of the regeneration materials has been melted from a raw material mixture having a proportion of potassium oxide in the range from 20 percent by mass to 40 percent by mass, especially in the range from 25 percent by mass to 35 percent by mass, or of 32.5 percent by mass.

Moreover, alternatively or additionally, it may advantageously be the case that at least one of the regeneration materials has been melted from a raw material mixture having a proportion of aluminum oxide in the range from 1 percent by mass to 10 percent by mass, especially in the range from 2 percent by mass to 6 percent by mass, or of 2.5 percent by mass or of 5 percent by mass.

In addition, alternatively or additionally, it may advantageously be the case that at least one of the regeneration materials has been melted from a raw material mixture having a proportion of calcium oxide in the range from 0 percent by mass to 15 percent by mass, especially in the range from 6 percent by mass to 10 percent by mass, or of 8 percent by mass.

Furthermore, alternatively or additionally, it may advantageously be the case that at least one of the regeneration materials has been melted from a raw material mixture having a proportion of boron oxide in the range from 0 percent by mass to 10 percent by mass.

A particularly advantageous execution is one in which at least one of the regeneration materials contains at least one alkaline earth metal.

For example, at least one of the regeneration materials may have been melted from a raw material mixture including 2.5 percent by mass of aluminum oxide, 32 percent by mass of potassium oxide, 8 percent by mass of calcium oxide and 57.5 percent by mass of silicon oxide. It has been found that such a regeneration material which is introduced into a contaminated salt melt bath with a proportion by mass of 5% can achieve lowering of the original sodium content by 60% or more within 24 hours.

For example, at least one of the regeneration materials may have been melted from a raw material mixture including 5 percent by mass of aluminum oxide, 32.5 percent by mass of potassium oxide, 8 percent by mass of calcium oxide and 54.5 percent by mass of silicon oxide. It has been found that such a regeneration material can be used particularly efficiently in the form of a nonwoven in a separate channel through which the salt melt to be regenerated flows continually or at time intervals.

In particular, it may advantageously quite generally be the case that the first regeneration material is designed to take up a first ionic constituent, for example sodium ions, from the salt melt, and that the second regeneration material is designed to take up a second ionic constituent, for example lithium ions, from the salt melt, which is different than the first ionic constituent.

The at least one first regeneration material body and/or the at least one second regeneration material body may, for example, be introduced directly into a salt bath containing the salt melt or be disposed in a channel through which the salt melt flows continually or at time intervals. There are no fundamental restrictions with regard to the mode of contacting.

Alternatively, and in a particularly advantageous manner, the at least one first regeneration material body may be disposed in a vessel, especially in a basket or screen, and contacted with the salt melt, where the vessel has at least one opening through which the molten salt of the salt melt can flow without the first regeneration material being able to escape from the vessel. Alternatively or additionally, it may analogously advantageously be the case that the at least one second regeneration material body is disposed in a vessel, especially in a basket or screen, and is contacted with the salt melt, where the vessel has at least one opening through which the molten salt of the salt melt can flow without the second regeneration material being able to escape from the vessel. Such an execution facilitates handling in the contacting with the salt melt and also permits the use of a multitude of small regeneration material bodies, for example in the form of a pelletized material or in the form of a plurality of small platelets, and a large surface area is ultimately available as contact area with the salt melt.

The at least one first regeneration material body and the at least one second regeneration material body may be disposed in a common vessel when simultaneous contacting with the salt melt is intended. However, the at least one first regeneration material body and the at least one second regeneration material body are preferably each disposed in a dedicated vessel, which are handled separately, and are especially also contacted with the salt melt sequentially or with a time delay.

The vessel may advantageously take the form, for example, of a cage, basket or screen. The vessel is preferably manufactured from stainless steel. In this way, chemical reaction with the salt melt or the regeneration material or the glass articles to be hardened and/or solidified is avoided.

It is particularly advantageous when the regeneration material bodies are agitated in the salt melt, especially continually or at time intervals, in order to constantly bring different parts of the salt melt into contact with the regeneration material bodies. It is alternatively or additionally also possible that a respective portion of the salt melt is taken continually or at time intervals from a salt bath in which the glass hardening and/or glass solidification process is taking place and contacted with at least one of the regeneration material bodies, especially in flowing contact, and the respectively removed portion of the salt melt is then introduced back into the salt bath.

In an advantageous execution, a portion of the salt melt is guided continually or at time intervals through a channel in which the at least one first regeneration material body and/or the at least one second regeneration material body are present.

The salt melt may especially include potassium and/or potassium nitrate or consist (disregarding impurities) of potassium nitrate or a mixture with potassium nitrate.

As already mentioned, a particularly advantageous method of hardening and/or solidifying glass articles is one in which the glass articles are contacted with a salt melt, wherein the salt melt is regenerated continually or at time intervals, in particular regular time intervals, by a method of the disclosure. In this way, it is advantageously possible to achieve the effect that the quality of the salt melt is maintained for a large number of glass hardening and/or glass solidifying operations and is subject to only minor fluctuations, or none.

In this case, it may advantageously in particular be the case that the at least one first regeneration material body and the glass articles are contacted with the salt melt in such a way that they are in contact with the salt melt simultaneously or at least with a time overlap. Alternatively or additionally, it may advantageously be the case that the at least one second regeneration material body and the glass articles are contacted with the salt melt in such a way that they are in contact with the salt melt simultaneously or at least with a time overlap. In this way, fluctuations in the quality of the salt melt are avoided or at least kept at a low level.

The plant of the disclosure for hardening and/or solidifying glass articles may include a first vessel which is introducible or has been introduced into the salt melt, including the at least one first regeneration material body, wherein the first vessel has at least one opening through which the molten salt of the salt melt can flow. Alternatively or additionally, the plant may have a second vessel which is introducible or has been introduced into the salt melt, including the at least one second regeneration material body, wherein the second vessel has at least one opening through which the molten salt of the salt melt can flow.

Exchange of a vessel for another (preferably identical) vessel having at least one fresh regeneration material body is advisable when the regeneration material body disposed in the vessel no longer provides sufficient regeneration performance. In this case, it is advantageous that there are several first vessels of the same design (at least with respect to one another) and/or that there are several second vessels of the same design (at least with respect to one another). In particular, the first vessels and/or the second vessels may be designed as exchangeable cartridges.

The plant may especially include a first receptacle for receiving a first vessel with the at least one first regeneration material body. Alternatively or additionally, the plant may include a second receptacle for receiving a second vessel with the at least one second regeneration material body. The first receptacle and/or the second receptacle may be part of a channel through which the salt melt flows.

The first vessel and the second vessel may advantageously be of different design, especially with regard to shape and/or size. Such a design has the very particular advantage that inadvertent misidentification in the exchanging of the vessels is avoided. This may especially be supported in that the receptacles (for example on the basis of their shape and/or size) are designed such that a first vessel cannot be fitted into a second receptacle and/or a second vessel cannot be fitted into a first receptacle.

Quite generally, it may advantageously be the case that the regeneration material bodies are contacted with the salt melt continually or at time intervals. This can be effected, for example, in that the regeneration material bodies are accommodated in a tank containing the salt melt to be regenerated. The regeneration material bodies are particularly effective when they and the salt melt are moved relative to one another, in order that different parts of the salt melt constantly come into contact with the regeneration material bodies. In this respect, the plant of the disclosure may advantageously have a movement device that moves at least one of the regeneration material bodies within the salt melt and/or moves them into the salt melt, continually or at time intervals.

Alternatively, as already mentioned, it may also be the case that at least one of the regeneration material bodies is disposed in a separate channel through which the salt melt to be regenerated flows continually or at time intervals. The plant of the disclosure may advantageously have a pump for pumping the salt melt through the channel. The channel is preferably actively heated in order to prevent any drop in temperature of the salt melt within the channel and hence solidification of the salt melt in the channel.

### BRIEF DESCRIPTION OF THE DRAWING VIEWS

The drawing illustrates the subject matter of the disclosure by way of example and in schematic form and is also described hereinafter with reference to the figures, where identical elements or elements having the same effect are also usually given the same reference numerals in different working examples.

FIGS. 1 to 4 schematically show a first working example of a plant of the disclosure for hardening and/or solidifying glass articles in various situations in the execution of a working example of a method of the disclosure,

FIGS. 5 to 10 schematically show a second working example of a plant of the disclosure for hardening and/or solidifying glass articles in various situations in the execution of a working example of a method of the disclosure,

FIG. 11 schematically shows a third working example of a plant of the disclosure for hardening and/or solidifying glass articles, and

FIG. 12 schematically shows a fourth working example of a plant of the disclosure for hardening and/or solidifying glass articles.

### DETAILED DESCRIPTION

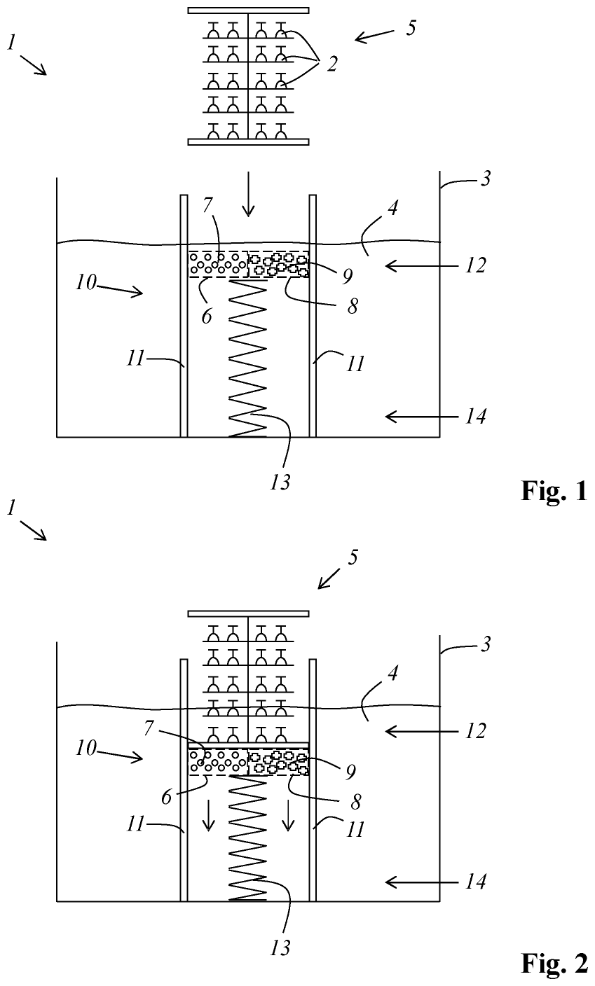

FIGS. 1 to 4 show a first working example of an inventive plant 1 for hardening and/or solidifying glass articles 2 (illustrated here merely by way of example in the form of wineglasses) in various situations in the execution of a working example of a method of the disclosure.

The plant 1 has a tank 3 containing a salt melt 4, into which a carrier 5 bearing at least one glass article 2 to be hardened and/or solidified can be immersed by an immersing motion and from which the carrier can then be removed again by a surfacing motion.

The plant 1 has a first vessel 6 in which there are disposed two or more first regeneration material bodies 7. The first vessel 6 has openings through which the salt melt 4 can flow but through which the first regeneration material bodies 7 cannot escape. The first vessel 6 may especially take the form of a basket with a closable lid or of a closed screen with a closable lid.

The plant 1 also has a second vessel 8 in which there are disposed two or more second regeneration material bodies 9. The second vessel 8 has openings through which the salt melt 4 can flow but through which the second regeneration material bodies 9 cannot escape. The second vessel 8 may especially take the form of a basket with a closable lid or of a closed screen with a closable lid.

The first regeneration material bodies 7 consist of a first regeneration material, while the second regeneration material bodies 9 consist of a second regeneration material other than the first regeneration material.

A guide device 10 having multiple guide rails 11 is disposed in the tank 3. The guide device 10 guides the carrier 5 and the first vessel 6 and the second vessel 8 during the immersing motion and the surfacing motion.

FIG. 1 shows the situation before the execution of the immersing motion of the carrier 5. The first vessel 6 and the second vessel 8 are in this situation in a first function position 12. The first vessel 6 and the second vessel 8 are held in the first function position 12 horizontally by the guide device 6 and vertically by means of a spring device 13. The spring device 13 abuts the base of the tank 3 at one end and the base of the first vessel 6 and the base of the second vessel 8 at the other end.

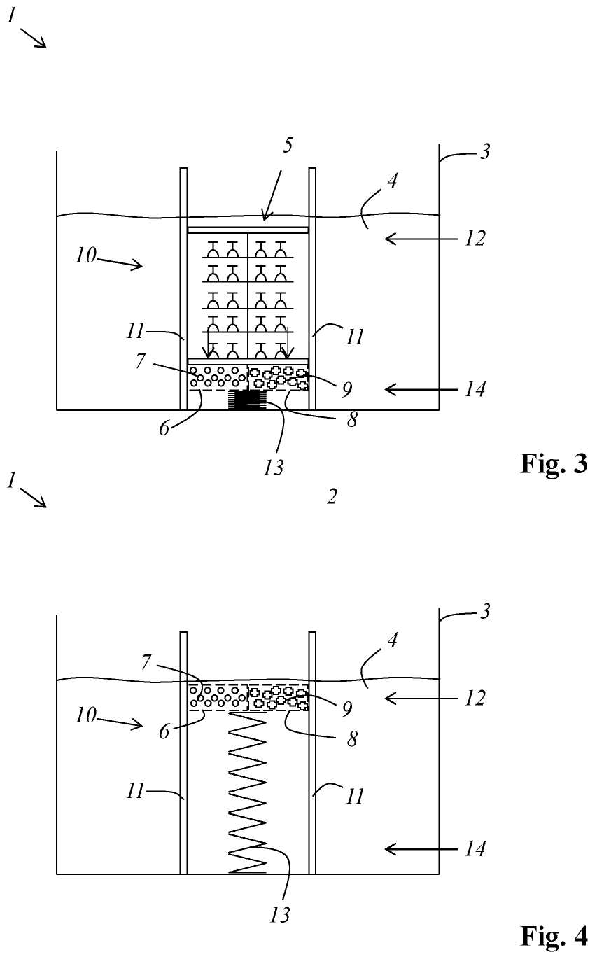

FIG. 2 shows the situation during the immersing motion. The carrier 5, for example by means of a robot (not shown) or a transport device (not shown), is moved via the guide device 10 and then vertically downward, such that it comes into active contact with the guide device 10, and is guided by the guide rails 11 during further vertical motion. The carrier 5, by virtue of its immersing motion, pushes the first vessel 6 and the second vessel 8 downward against the force of the spring device 13 from the first function position 12, until the first vessel 6 and the second vessel 8 arrive in a second function position 14, as shown in FIG. 3.

In the surfacing motion (not shown), in which the carrier 5 together with the glass articles 2 to be hardened and/or solidified are removed again from the glass melt 4, the first vessel 6 and the second vessel 8 are forced back upward by the spring device 13 from the second function position 14 until they arrive back in the first function position 12, as shown in FIG. 4. The carrier 5 can then be refilled and immersed again, or the next newly filled carrier 5 can be immersed. In each immersing motion and in each surfacing motion, a portion of the salt melt 4 flows through the openings in the first vessel 6 and the second vessel 8 and hence comes into contact with the first regeneration material bodies 7 and the second regeneration material bodies 9. Moreover, the salt melt 4 is mixed thereby, and so a homogeneous distribution of all ingredients within the tank 3 is achieved.

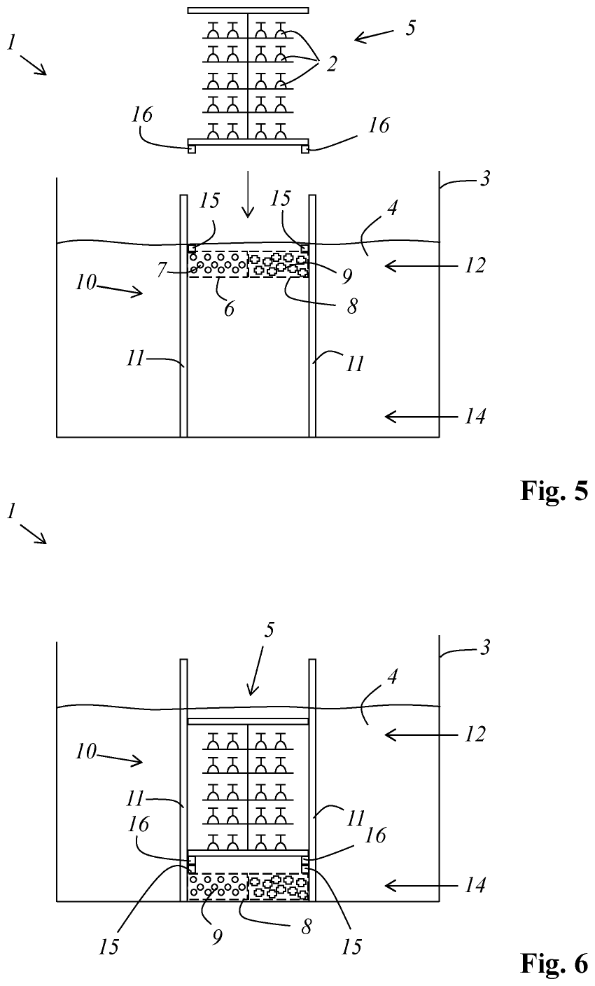

FIGS. 5 to 10 show a second working example of an inventive plant 1 for hardening and/or solidifying glass articles 2 in various situations in the execution of a working example of a method of the disclosure. The apparatus 1 has a tank 3 containing a salt melt 4 into which a carrier 5 bearing at least one glass article 2 to be hardened and/or solidified can be immersed by an immersing motion and from which the carrier 5 can then be removed again by a surfacing motion.

The plant 1 has a first vessel 6 in which there are disposed two or more first regeneration material bodies 7. The first vessel 6 has openings through which the salt melt 4 can flow, but through which the first regeneration material bodies 7 cannot escape. The first vessel 6 may especially be designed as a basket having a closable lid or as a closed screen having a closable lid.

The plant 1 also has a second vessel 8 in which there are disposed two or more second regeneration material bodies 9. The second vessel 8 has openings through which the salt melt 4 can flow, but through which the second regeneration material bodies 9 cannot escape. The second vessel 8 may especially take the form of a basket having a closable lid or of a closed screen having a closable lid.

The first regeneration material bodies 7 consist of a first regeneration material, while the second regeneration material bodies 9 consist of a second regeneration material other than the first regeneration material.

Disposed in the tank 3 is a guide device 10 having several guide rails 11. The guide device 10 guides the carrier 5, and also the first vessel 6 and the second vessel 8, during the immersing motion and the surfacing motion. The guide device 10 in this working example is designed such that the first vessel 6 and the second vessel 8 remain fixed in their respective current vertical position if they are not actively being pulled upward or pushed downward by means of the carrier 5.

FIG. 5 shows the situation prior to the execution of the immersing motion of the carrier 5. The first vessel 6 and the second vessel 8 in this situation are in a first function position 12. The first vessel 6 and the second vessel 8 are held in the first function position 12 horizontally and vertically by the guide device 10.

The first vessel 6 and the second vessel 8 have coupling elements 15, and the carrier 5 has complementary coupling elements 16, by means of which the first vessel 6 and the second vessel 8 are securable in a redetachable manner on the carrier 5. In particular, it may advantageously be the case that a snap-fit connection is produced by means of the coupling elements 15 and the complementary coupling elements 16, especially automatically or under external control, when carrier 5 is placed onto the first vessel 6 and the second vessel 8. Moreover, alternatively or additionally, it may advantageously be the case that the snap-fit connection is released automatically or under external control when the first vessel 6 and the second vessel 8, after a surfacing motion, have reached the first function position 12 or a maintenance position 17, which is elucidated in detail further down.

The carrier 5, for example by means of a robot (not shown) or a transport device (not shown), is moved via the guide device 10 and then vertically downward, such that it comes into active contact with the guide device 10, and is guided by the guide rails 11 during further vertical motion. The carrier 5, by virtue of its immersing motion, pushes the first vessel 6 and the second vessel 8 downward from the first function position 12 until the first vessel 6 and the second vessel 8 arrive in a second function position 14, as shown in FIG. 6. FIG. 6 shows the situation after the execution of the immersing motion.

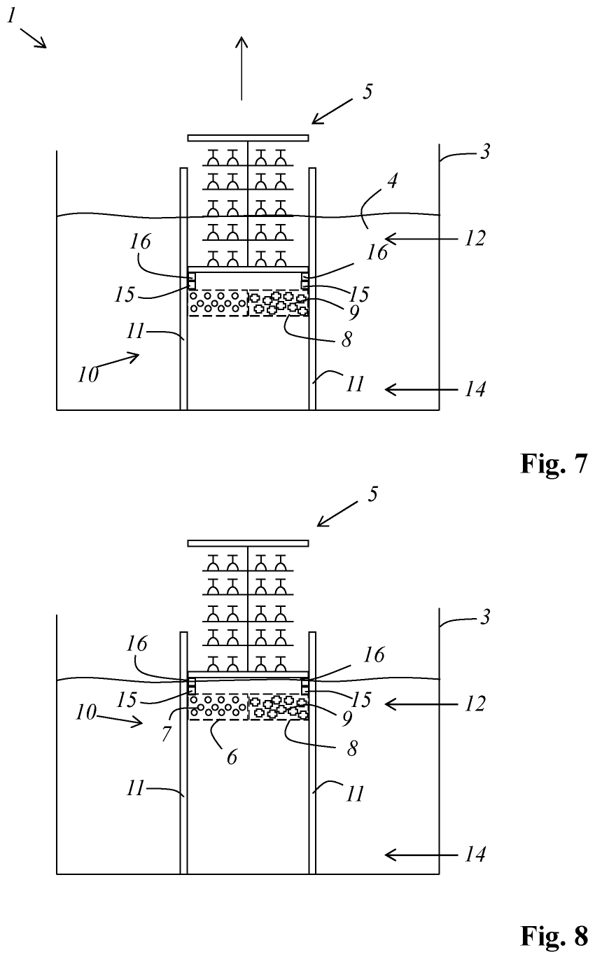

FIG. 7 shows the situation during the surfacing motion, in which the carrier 5 together with the glass articles 2 to be hardened and/or solidified is removed again from the glass melt 4. The carrier 5 here pulls the first vessel 6 and the second vessel 8, which are coupled by means of the coupling elements 15 and the complementary coupling elements 16, upward until the first vessel 6 and the second vessel 8 reach the first function position 12.

Subsequently, the active connection of the coupling elements 15 and the complementary coupling elements 16 can be parted and the carrier 5 can be removed. The carrier 5 can then be refilled and immersed again, or the next newly filled carrier 5 can be immersed. In each immersing motion and in each surfacing motion, a portion of the salt melt 4 flows through the openings in the first vessel 6 and through the openings in the second vessel 8 and hence comes into contact with the regeneration material bodies 7 and the regeneration material bodies 9. Moreover, the salt melt 4 is mixed thereby, and so a homogeneous distribution of all ingredients within the tank 3 is achieved.

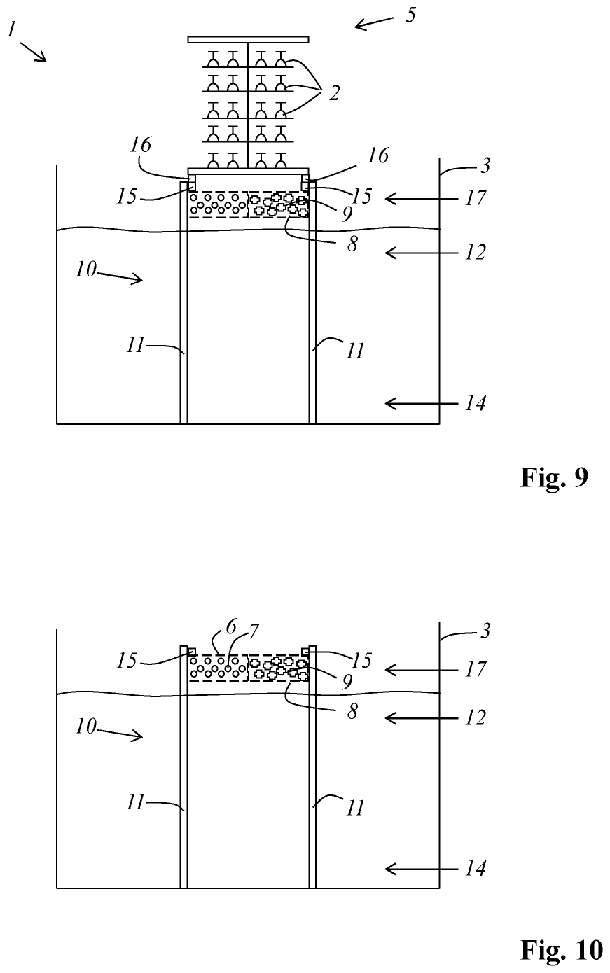

The regeneration material 9, for example after a defined or definable number of hardening and/or solidifying operations, has to be exchanged. In order to be able to undertake an exchange, the first vessel 6 and the second vessel 8 are transferred to a maintenance position 17 outside the salt melt 4. For this purpose, the coupling of the first vessel 6 and the second vessel 8 to the carrier 5 is not released after the surfacing motion, such that the carrier 5 can pull the vessels 6, 8 beyond the first function position 12 out of the salt melt 4 into the maintenance position 17, as shown in FIG. 9. Subsequently, the active connection of the coupling elements 15 and the complementary coupling elements 16 can be parted and the carrier 5 can be removed.

The spent first regeneration material bodies 7 and/or the spent second regeneration material bodies 9 can be removed from the vessels 6, 8 in the maintenance position 17, and new first regeneration material bodies 7 and/or new second regeneration material bodies 9 can be introduced. It is alternatively also possible to exchange the first vessel 6 for a first vessel 6 already filled with fresh first regeneration material bodies 7 and/or to exchange the second vessel 8 for a second vessel 8 already filled with fresh second regeneration material bodies 9. For this purpose, it may advantageously be the case that the respective vessel 6, 8 is removed from the maintenance position 17, and a vessel 6, 8 filled with new regeneration material bodies 7, 9 is brought into the maintenance position 17.

Subsequently, the first vessel 6 and the second vessel 8 can be coupled again to a carrier 5 and transferred into the salt melt 4.

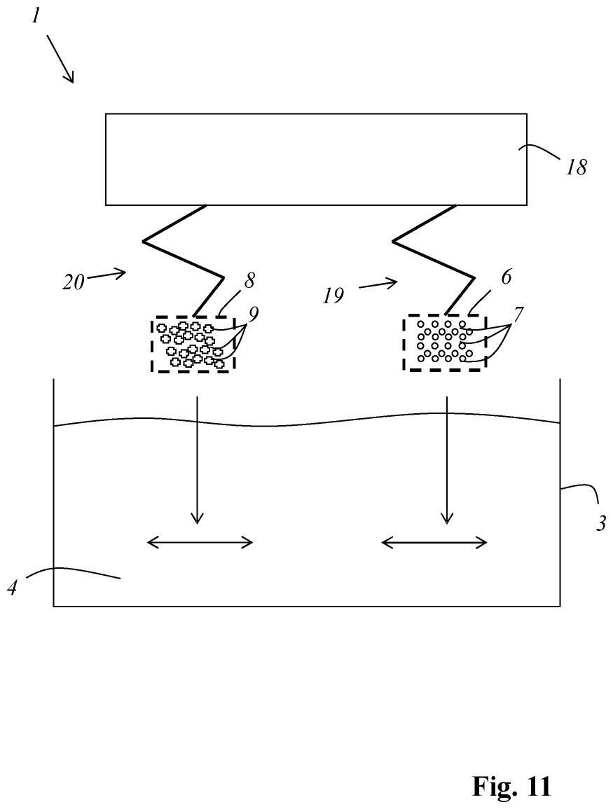

FIG. 11 shows a third working example of an inventive plant 1 for curing and/or solidifying glass articles 2 (not shown in FIG. 11), having a tank 3 containing a salt melt 4. The salt melt 4 includes potassium nitrate, for example, or consists of potassium nitrate, for example.

The plant 1 has a movement device 18. The movement device 18 has a first robot arm 19 that bears a first vessel 6 in which there are disposed two or more first regeneration material bodies 7. The movement device 18 also has a second robot arm 20 that bears a second vessel 8 in which there are disposed two or more second regeneration material bodies 9. It would alternatively also be possible for a single robot arm to simultaneously or successively handle the first vessel 6 and the second vessel 8.

The first vessel 6 and the second vessel 8 have openings through which the salt melt 4 can flow. The first regeneration material bodies 7 consist of a first regeneration material, while the second regeneration material bodies 9 consist of a second regeneration material other than the first regeneration material.

The openings in the first vessel 6 are such that the first regeneration material bodies 7 cannot pass through them. The openings in the second vessel 8 are such that the second regeneration material bodies 9 cannot pass through them.

By means of the movement device 18, the first vessel 6 is immersed into the salt melt 4. The movement device 18 can also move the first vessel 6 within the salt melt 4, which enhances the effect of the first regeneration material 7. By means of the movement device 3, the second vessel 8 is also immersed into the salt melt 4. The movement device 18 can also move the second vessel 8 within the salt melt 4, which enhances the effect of the first regeneration material 9. The movement device 18 can be controlled such that the first vessel 6 and the second vessel 8 are contacted with the salt melt 4 at time intervals. However, it is also possible that the first vessel 6 and the second vessel 8 are contacted with the salt melt 4 simultaneously or with a time overlap.

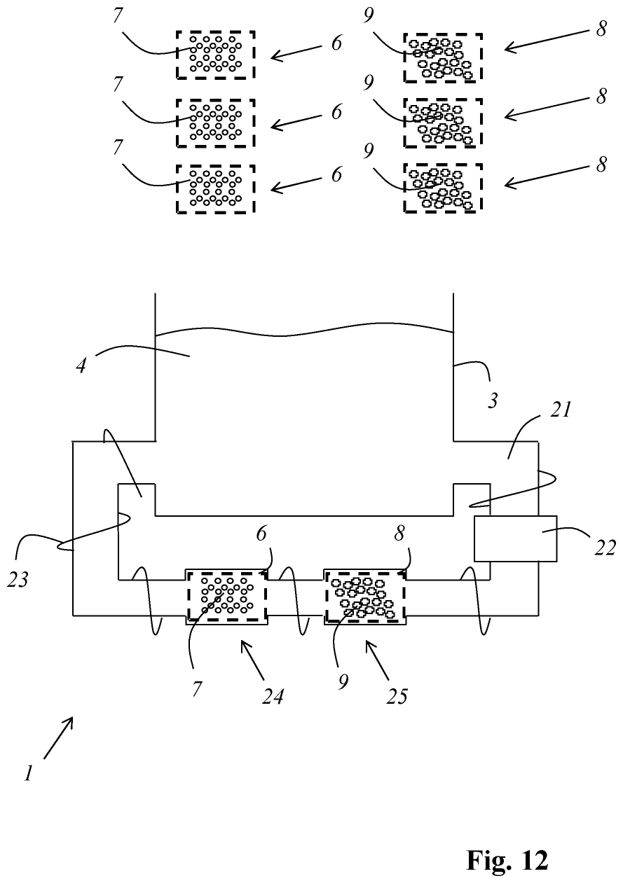

FIG. 12 shows a fourth working example of a plant of the disclosure for hardening and/or solidifying glass articles 2 (not shown in FIG. 12), having a tank 3 containing a salt melt 4. The salt melt 4 may include potassium nitrate, for example, or consist (disregarding impurities) of potassium nitrate.

The tank 3 is connected at two sites to a channel 21 in which there is a pump 22. By means of the pump 22, a respective portion of the salt melt 4 is taken from the tank 3 and, after passing through the channel 21, fed back to the tank 3. The channel 21 is actively heated by means of a heating wire 23 in order to avoid any drop in temperature in the salt melt 4 within the channel 21 and hence solidification of the salt melt 4 in the channel 21.

Within the channel 21 is a first receptacle 24 for receiving a first vessel 6 containing the at least one first regeneration material body 7. Within the channel 21, there is also a second receptacle 25 for receiving a second vessel 8 containing the at least one second regeneration material body 9.

Moreover, the plant 1 has two or more further first vessels 6 containing first regeneration material bodies 7 and two or more further second vessels 8 containing second regeneration material bodies 9 that can be inserted into the respective receptacle 24, 25 when the first regeneration material bodies 7 or second regeneration material bodies 9 respectively present in the first receptacle 24 and in the second receptacle 25 are spent.

### LIST OF REFERENCE NUMERALS

1 plant
2 glass articles
3 tank
4 salt melt
5 carrier
6 first vessel
7 first regeneration material body
8 second vessel
9 second regeneration material body
10 guide device
11 guide rails
12 first function position
13 spring device
14 second function position
15 coupling elements
16 complementary coupling elements
17 maintenance position
18 movement device
19 first robot arm
20 second robot arm
21 channel
22 pump
23 heating wire
24 first receptacle
25 second receptacle

What is claimed is:

1. A method of regenerating a salt melt (4) for a glass hardening and/or glass solidification process, characterized in that at least one first regeneration material body (7) composed of a first regeneration material and a second regeneration material body (9) composed of a second regeneration material other than the first regeneration material is contacted simultaneously or sequentially with the salt melt (4).

2. The method as claimed in claim 1, characterized in that two or more first regeneration material bodies (7) composed of the first regeneration material and/or two or more second regeneration material bodies (9) composed of the second regeneration material are contacted simultaneously or sequentially with the salt melt (4).

3. The method as claimed in claim 2, characterized in that
a. the first regeneration material bodies (7) have a mutually identical or at least similar shape and/or size, and/or in that
b. the second regeneration material bodies (9) have a mutually identical or at least similar shape and/or size.

4. The method as claimed in claim 1, characterized in that the at least one first regeneration material body (7) differs from the at least one second regeneration material body in terms of shape and/or size.

5. The method as claimed in claim 1, characterized in that the at least one first regeneration material body (7) takes the form of a sphere or of a sheet or of a corrugated sheet or of a corrugated sheet with an irregular surface in the form of a frit or in the form of fibers, and/or in that the at least one second regeneration material body (9) takes the form of a sphere or of a sheet or of a corrugated sheet or of a frit.

6. The method as claimed in claim 1, characterized in that at least one of the regeneration materials is a glass or includes a glass.

7. The method as claimed in claim 6, characterized in that at least one of the regeneration materials is a glass composed of a glass system with a tendency to separate or includes a glass composed of a glass system with a tendency to separate.

8. The method as claimed in claim 6, characterized in that at least one of the regeneration materials is a silicon dioxide-rich glass or includes a silicon dioxide-rich glass.

9. The method as claimed in claim 6, characterized in that at least one of the regeneration materials is a VYCor glass or includes a VYCor glass.

10. The method as claimed in claim 1, characterized in that at least one of the regeneration materials includes amorphous silica.

11. The method as claimed in claim 1, characterized in that one of the regeneration materials is designed to take up calcium from the salt melt (4).

12. The method as claimed in claim 1, characterized in that one of the regeneration materials includes calcium, but is designed not to release calcium into the salt melt (4).

13. The method as claimed in claim 1, characterized in that at least one of the regeneration materials is designed to take up lithium from the salt melt (4).

14. The method as claimed in claim 1, characterized in that one of regeneration materials includes lithium, but is designed not to release lithium into the salt melt (4).

15. The method as claimed in claim 1, characterized in that one of the regeneration materials is potassium-containing silicate glass.

16. The method as claimed in claim 1, characterized in that one of the regeneration materials has been melted from a raw material mixture including, apart from potassium oxide, additionally at least one further oxide.

17. The method as claimed in claim 1, characterized in that
a. one of the regeneration materials has been melted from a raw material mixture including, apart from potassium oxide, additionally two or more oxides, or in that
b. one of the regeneration materials has been melted from a raw material mixture including, apart from potassium oxide, additionally two or more oxides.

18. The method as claimed in claim 1, characterized in that one of the regeneration materials has been melted from a raw material mixture having a proportion of silicon oxide in the range from 40 percent by mass to 75 percent by mass.

19. The method as claimed in claim 1, characterized in that one of the regeneration materials has been melted from a raw material mixture having a proportion of potassium oxide in the range from 20 percent by mass to 40 percent by mass.

20. The method as claimed in claim 1, characterized in that one of the regeneration materials has been melted from a raw material mixture having a proportion of aluminum oxide in the range from 1 percent by mass to 10 percent by mass.

21. The method as claimed in claim 1, characterized in that one of the regeneration materials has been melted from a raw material mixture having a proportion of calcium oxide in the range from 0 percent by mass to 15 percent by mass.

22. The method as claimed in claim 1, characterized in that one of the regeneration materials has been melted from a raw material mixture having a proportion of boron oxide in the range from 0 percent by mass to 10 percent by mass.

23. The method as claimed in claim 1, characterized in that one of the regeneration materials contains at least one alkaline earth metal.

24. The method as claimed in claim 1, characterized in that the first regeneration material is designed to take up a first ionic constituent from the salt melt (4), and in that the second regeneration material is designed to take up a second ionic constituent from the salt melt (4) other than the first ionic constituent.

25. The method as claimed in claim 1, characterized in that
a. the at least one first regeneration material body (7) is disposed in a first vessel (6), and is contacted with the salt melt (4), wherein the vessel has at least one opening through which the molten salt of the salt melt (4) can flow without the at least one first regeneration material body (7) being able to escape from the first vessel (6), and/or in that
b. the at least one second regeneration material body (9) is disposed in a second vessel (8), and is contacted with the salt melt (4), wherein the second vessel (8) has at least one opening through which the molten salt of the salt melt (4) can flow without the at least one second regeneration material body (9) being able to escape from the second vessel (8).

26. The method as claimed in claim 25, characterized in that the first vessel (6) and/or the second vessel (8) are manufactured from stainless steel.

27. The method as claimed in claim 1, characterized in that the at least one first regeneration material body (7) and/or the at least one second regeneration material body (9) are agitated in the salt melt (4).

28. The method as claimed in claim 1, characterized in that a portion of the salt melt (4) is guided continually or at time intervals through a channel (21) in which the at least one first regeneration material body (7) and/or the at least one second regeneration material body (9) are present.

29. The method as claimed in claim 1, characterized in that the salt melt (4) includes potassium and/or potassium nitrate.

30. The method as claimed in claim 1, characterized in that at least one further regeneration material body composed of a further regeneration material other than the first and second regeneration materials is used for regeneration of the salt melt by simultaneous or sequential contacting.

31. A method of hardening and/or solidifying glass articles, in which the glass articles are contacted with a salt melt (4), characterized in that the salt melt (4) is regenerated continually or at time intervals by a method as claimed in claim 1.

32. The method as claimed in claim 31, characterized in that
a. the at least one first regeneration material body (7) and the glass articles (2) are contacted with the salt melt (4) in that they are in contact with the salt melt (4) simultaneously or at least with a time overlap, and/or in that
b. the at least one second regeneration material body (9) and the glass articles (2) are contacted with the salt melt (4) in that they are in contact with the salt melt (4) simultaneously or at least with a time overlap.

33. A plant (1) for hardening and/or solidifying glass, including a salt bath containing a salt melt (4), characterized in that the plant (1) includes at least one first regeneration material body (7) composed of a first regeneration material and at least one second regeneration material body (9) composed of a second regeneration material other than the first regeneration material that are continually in contact with the salt melt (4) or are simultaneously or sequentially contactable with the salt melt (4).

34. The plant (1) as claimed in claim 33, characterized in that the plant (1) includes a first vessel (6) which is introducible or has been introduced into the salt melt (4) and which includes the at least one first regeneration material body (7), where the first vessel (6) has at least one opening through which the molten salt of the salt melt (4) can flow, and/or in that the plant (1) includes a second vessel (8) which is introducible or has been introduced into the salt melt (4) and which includes the at least one first regeneration material body (9), where the second vessel (8) has at least one opening through which the molten salt of the salt melt (4) can flow.

35. (canceled)

36. (canceled)

37. (canceled)

38. The plant (1) as claimed in claim 34, characterized in that the first vessel (6) and/or the second vessel (8) take the form of exchangeable cartridges.

39. The plant (1) as claimed in claim 33, characterized in that the plant (1) has a movement device (18) that moves the regeneration material bodies (7, 9) within the salt melt (4) and/or moves them into the salt melt (4), continually or at time intervals.

40. The plant (1) as claimed in claim 33, characterized in that the plant (1) has a channel (21) in which the first and/or the second regeneration material body (9) are present and through which a portion of the salt melt (4) can be conducted continually or at time intervals.

41. (canceled)

42. The plant (1) as claimed in claim 33, characterized in that the plant has at least one further regeneration material body composed of a further regeneration material other than the first and second regeneration materials.
